(19) United States
(12) Patent Application Publication
(10) Pub. No.: US 2005/0085341 A1
(43) Pub. Date: Apr. 21, 2005

(54) Detection device for detecting the wish of a driver of a motor vehicle for a particular overall thrust torque of the motor vehicle

(76) Inventors: Guenter Kettenacker, Steinheim (DE); Ralf Schernewski, Karlsruhe (DE)

Correspondence Address: KENYON & KENYON, ONE BROADWAY, NEW YORK, NY, 10004, US

(21) Appl. No.: 10/959,284

(22) Filed: Oct. 5, 2004

(30) Foreign Application Priority Data
Oct. 16, 2003 (DE) 103 48 249.0

(51) Int. Cl. B60K 41/04

(52) U.S. Cl. 477/107

(57) ABSTRACT

A detection device for detecting the wish of the driver of a motor vehicle for an instantaneous overall thrust torque to be supplied by the motor vehicle during an overrun operation, by analyzing at least two of the following signals: a brake signal, a power transmission signal, an accelerator signal, a speed signal and/or a status signal, which represents the status of a vehicle speed controller of the motor vehicle, and for outputting a driver input signal, which represents this desired overall thrust torque. Also described is a device, a method and a computer program for setting or realizing the desired overall thrust torque.

### FIELD OF THE INVENTION

The present invention relates to a detection device for detecting the wish of a driver of a motor vehicle for a change in the overall thrust torque currently provided by the motor vehicle, by analyzing a plurality of significant measuring variables of the vehicles. The present invention also relates to a device, a method and a computer program for realizing this driver wish.

### BACKGROUND INFORMATION

In connection with motor vehicles having internal combustion engines, in particular diesel gasoline engines, it is understood from the related art to shift these vehicles into overrun operation when it is determined, by analyzing an accelerator pedal signal, that the driver of the motor vehicle is not activating the accelerator. Overrun operation, also called unfiring overrun operation, means that no torque-generating injections take place into the internal combustion engine. In overrun operation, the internal combustion engine in conjunction with various ancillary components of the motor vehicle generates a thrust torque that is made up of the negative sum of their friction torques and torque losses, which is translated according to the gear transmission ratio. This results in a slight overall delay for the vehicle response.

The described detection of a non-activation of the accelerator may be interpreted as a driver wish to initiate overrun operation. In the related art, overrun operation is initiated when the corresponding accelerator setting is detected by the components of the motor vehicles that are activated because of the instantaneous driving situation and the instantaneous operating state, i.e., in particular by the internal combustion engine and various ancillary components. While the overall thrust torque that will then result as actual variable is situation-dependent, as mentioned earlier, it is otherwise essentially constant.

However, the overall thrust torque that will automatically come about when overrun operation is initiated may not correspond to a driver-desired overall thrust torque for the entire duration of overrun operation. In other words: During overrun operation, it may happen that the driver desires a change in the acting overall thrust torque from the automatically resulting overall thrust torque.

### SUMMARY OF THE INVENTION

An object of the exemplary embodiment of the present invention is to provide a detection device for detecting the wish of a driver of a motor vehicle for a specific overall thrust torque that the motor vehicle is to supply during an instantaneous overrun operation, as well as a device, a method and a computer program for realizing this.

This objective is achieved by a detection device for detecting the wish of a driver of a motor vehicle for a specific overall thrust torque to be supplied by the motor vehicle during an instantaneous overrun operation, by analyzing at least two of the following signals: a brake signal, which represents a driver-initiated activation of the brake pedal; an accelerator signal, which represents the instantaneous position of the accelerator; a speed signal which represents the actual speed of the vehicle; a power transmission signal, which represents a power transmission in the power train of the motor vehicle; and/or a status signal, which represents the status of a driving speed controller of the motor vehicle; and for outputting a driver input signal, which represents this desired overall thrust torque.

In an advantageous manner, the detection device provides for detecting the wish of the motor vehicle driver for a specific overall thrust torque that is to be provided by the motor vehicle during an instantaneous overrun operation. That is to say, the subject matter of the exemplary embodiment of the present invention does not primarily relate to the wish of the driver for the initiation of overrun operation, but to a possibly desired change in the overall thrust torque during an existing overrun operation.

Overrun operation within the meaning of the exemplary embodiment of the present invention denotes non-firing overrun operation, i.e., no torque-generating injections into the internal combustion engine of the motor vehicle are taking place.

Four exemplary embodiments are introduced first to realize the exemplary detection devices of the present invention. On the one hand, these exemplary embodiments may be considered alternatives, each of these alternatives by itself representing a functional realization of the detection device. On the other hand, however, these exemplary embodiments, in any combination with each other, may also constitute further exemplary embodiments for realizing the detection device. In this case, at least two of the original exemplary embodiments are to be provided in each case and their individual driver input signals must then be analyzed by an evaluation device, which is to be provided in addition, so as to finally derive therefrom a common driver input signal.

In an advantageous manner, this evaluation consists of an averaging of the individual expressions of the driver wish for a change in the overall thrust torque, these expressions being represented by the individual driver input signals.

However, as an alternative to averaging, the evaluation device may select the least expressed or the most highly expressed driver input.

In addition, the aforementioned objective of the exemplary embodiment of the present invention is achieved by a device for coordinating the thrust torque of an internal combustion engine in a motor vehicle and by a method and a computer program for implementing this coordination in response to the driver input signal provided by the detection device. The advantages of these achievements correspond to the advantages mentioned in connection with the claimed detection device.

### BRIEF DESCRIPTION OF THE DRAWINGS

FIG. 1 shows a first exemplary embodiment of the detection device according to the present invention.

FIG. 2 shows a second exemplary embodiment of the detection device according to the present invention.

FIG. 3 shows a third exemplary embodiment of the detection device according to the present invention.

FIG. 4 shows a fourth exemplary embodiment of the detection device according to the present invention.

FIG. 5 shows the basic schematic configuration of a detection device according to the present invention.

FIG. 6 shows the configuration of a device according to the present invention for coordination of the thrust torque of an internal combustion engine in a motor vehicle.

FIG. 7 shows the method for implementing a coordination of the thrust torque according to the present invention.

### DETAILED DESCRIPTION

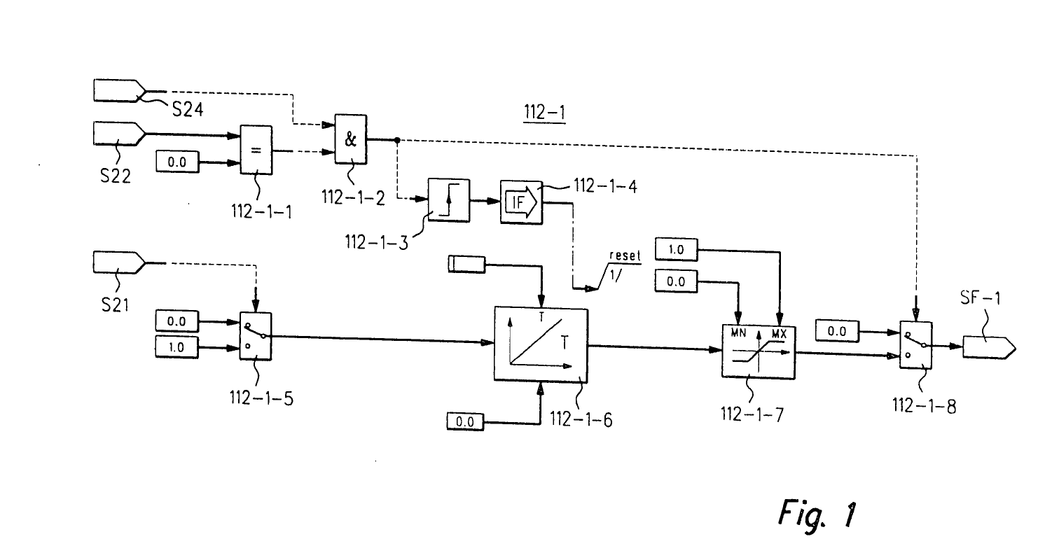

The exemplary embodiments of the present invention are discussed in greater detail in the form of the exemplary embodiments with reference to FIGS. 1 through 7.

FIG. 1 shows a first exemplary embodiment of a detection device 112-1 according to the present invention for detecting the wish of a driver of a motor vehicle (not shown here) for a specific overall thrust torque to be generated by the motor vehicle during a current overrun operation. In order to detect such a wish, the first exemplary embodiment shown in FIG. 1 analyzes a power-transmission signal S24, which represents a power transmission in the power train of the motor vehicle; an accelerator signal S22, which represents the instantaneous position of the accelerator; and a brake signal S21, which represents an activation of the brake pedal by the driver. A detailed description of the evaluation of these signals will be provided in the following.

Using a binary comparator unit 112-1-1, accelerator signal S22 is first analyzed with respect to ascertaining whether or not the accelerator is actually activated by the driver of the motor vehicle. In the exemplary embodiment illustrated in FIG. 1, a detected non-activation is represented by a logical one and a detected activation by a logical zero. This binary information, together with binary power-transmission signal S24, which represents a logical one in those cases where a power transmission is detected in the power train of the motor vehicle, is then sent to a logical AND-gate 112-1-2 as input variable. As long as no simultaneous non-activation of the accelerator and also a power transmission in the power train—symbolized by a logical one—are detected at both inputs of the AND-gate, AND-gate 112-1-2 transmits a logical zero as binary switching signal to the control input of a switching device 112-2-8. In response to this switching signal with a logical zero as content, switching device 112-2-8 outputs an individual driver input signal SF-1, which constitutes a decimal value of zero. This decimal zero value in turn represents the instantaneous wish of the driver of the motor vehicle for a minimally possible overall thrust torque.

As already mentioned previously, the first exemplary embodiment of detection device 112-1 according to the present invention also analyzes binary brake signal S21 by using it as binary control signal for a binary switching device 112-1-5. This binary switching device 112-1-5 generates a binary switching signal in the form of a logical zero at its output if brake signal S21 indicates no activation of the brake, and in the form of a logical one in the opposite case. As soon as an activation of the brake in the form of a logical one is detected at the output of binary switching device 112-1-5, this determination is used to start a digital integrator 112-1-6, which is provided downstream from binary switching device 112-1-5. This integrator 112-1-6 thereupon starts a counting operation, so that the particular instantaneous reading of this count represents the individual time duration during which the brake pedal is activated. In the first exemplary embodiment of the detection device according to the present invention as shown in FIG. 1, integrator 112-1-6 is reset under a certain condition. This condition is satisfied if a state change detector 112-1-3 detects a transition from a logical zero to a logical one at the output of logical AND-gate 112-1-2 and thereupon outputs a logical one at its own output, which is detected by a decision stage 112-1-4. In that case, this decision stage initiates a reset of integrator 112-1-6.

The decimal numerical value output by the integrator, which, as mentioned, represents the time duration during which the driver depresses the accelerator, is limited to a decimal value between zero and one by a limiting device 112-1-7 connected downstream from integrator 112-1-6. In this context, a decimal value of zero is interpreted as a driver wish for an overall thrust torque that is as low as possible and a decimal value of one as a driver wish for an overall thrust torque of the motor vehicle that is as high as possible. Due to the state change just described, from a logical zero to a logical one at the output of AND-gate 112-1-2, switching device 112-1-8 is switched over in such a way that it no longer receives the fixedly specified decimal value of zero at its input, but instead the decimal numerical value between zero and one, which is output by limiting device 112-1-7, and outputs it at its output in unchanged form, as individual driver input signal SF-1. The magnitude of this numerical value corresponds to the magnitude of the overall thrust torque currently desired by the driver.

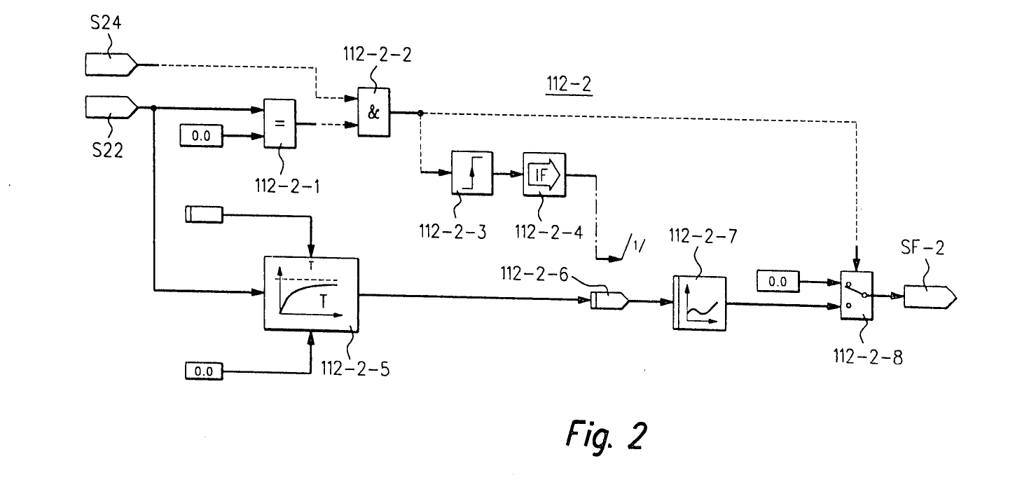

FIG. 2 shows a second exemplary embodiment of detection device 112-2 according to the present invention. It includes a binary comparator unit 112-2-1 for analyzing accelerator signal S22 and for generating a logical one at its output when the accelerator is not activated, and for generating a logical zero when the accelerator is activated. This binary output signal of comparator unit 112-2-1, together with binary power transmission signal S24, is sent to the inputs of a logical AND-gate 112-2-2. This AND-gate generates a logical zero at its output if either no power transmission—represented by power transmission signal S24—is present in the power train of the motor vehicle or if the accelerator is activated. However, if the accelerator is activated and if a power transmission is present in the power train at the same time, this will be indicated by the output of a logical one at the output of AND-gate 112-2-2. The output signal of AND-gate 112-2-2 is used as binary switching signal for a switching device 112-2-8. In the event that a logical zero is present at the output of AND-gate 112-2-2, switching device 112-2-8 outputs at its output a decimal zero in the form of an individual driver input signal SF-2. In exactly the same manner as already mentioned in the description of the first exemplary embodiment, the output of a zero is interpreted as a driver wish for the generation of the lowest possible overall thrust torque.

Furthermore, the second exemplary embodiment of detection device 112-2 includes a delay element 112-2-5 to delay accelerator signal S22. Delayed accelerator signal S22 is relayed to a memory device 112-2-6. In response to an enable signal, a respective instantaneous value of delayed accelerator signal S22 is stored in memory device 112-2-6. The enable signal is generated by a decision stage 112-2-4 in those cases where a state change detector 112-2-3 generates a logical one at its output, i.e., when it has detected a change of state from a logical zero to a logical one at the output of logical AND-gate 112-2-2. The value stored in memory device 112-2-6 in response to the enable signal is a measure of the dynamic response in the change of the accelerator position.

Connected downstream from memory device 112-2-6 is a characteristic curve evaluation device 112-2-7. Using a characteristic curve, the characteristic curve evaluation device interprets the value of delayed accelerator signal S22, which was stored and output by memory device 112-2-6, as the current driver wish for a specific thrust torque. If a logical one is present at the output of logical AND gate 112-2-2 and switching device 112-2-8 is therefore switched to the output of characteristic curve evaluation device 112-2-7, a numerical value, which is provided by characteristic curve evaluation device 112-2-7, is output via switching device 112-2-8 in the form of an individual driver input signal SF-2. This numerical value, which is usually greater than zero, then represents the specific overall thrust torque currently desired by the driver.

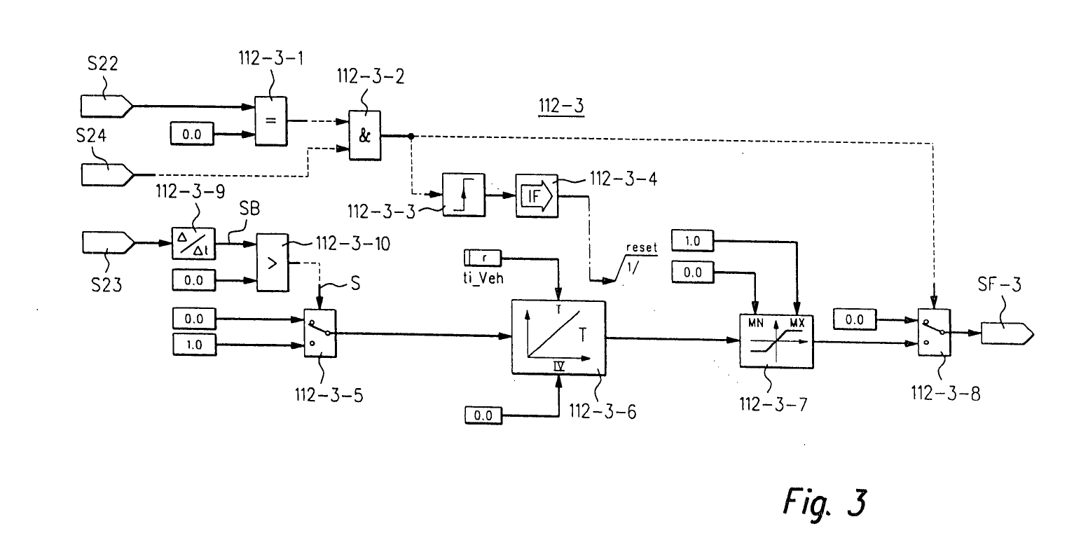

FIG. 3 shows a third exemplary embodiment of detection device 112-3 according to the present invention. As far as its description is concerned, reference is basically made to the description in connection with the first exemplary embodiment shown in FIG. 1. The components bearing reference numeral 112-3-x in FIG. 3 correspond to those bearing reference numeral 112-1-x in FIG. 1. The functioning method of the third exemplary embodiment essentially corresponds to the functioning method of the first exemplary embodiment. The sole difference between the third and the first exemplary embodiments is in the triggering of switching device 112-3-5. In the third exemplary embodiment according to FIG. 3, the control signal for triggering the switching device is formed in such a way that initially an acceleration detection device 112-3-9 is provided, which determines the instantaneous acceleration a of the vehicle by analyzing speed signal S23 and outputs it in the form of a numerical value, represented by an acceleration signal SB. A second comparator unit 112-3-10, which is connected downstream, then checks whether the ascertained current acceleration is greater than zero and generates binary control signal S to trigger switching device 112-3-5. If comparator unit 112-3-10 determines an acceleration that is greater than zero, the control signal may receive a logical value of one, otherwise it is given a logical value of zero.

At the output of switching device 112-3-8, the third exemplary embodiment then again generates an individual driver input signal SF-3, which represents the instantaneous driver wish for a specific overall thrust torque during an instantaneous overrun operation. The driver wish for an overall thrust torque that goes beyond the minimally possible overall thrust torque is registered as long as the motor vehicle is still accelerating, notwithstanding the fact that a power transmission is present in the power train of the vehicle and the accelerator is not activated.

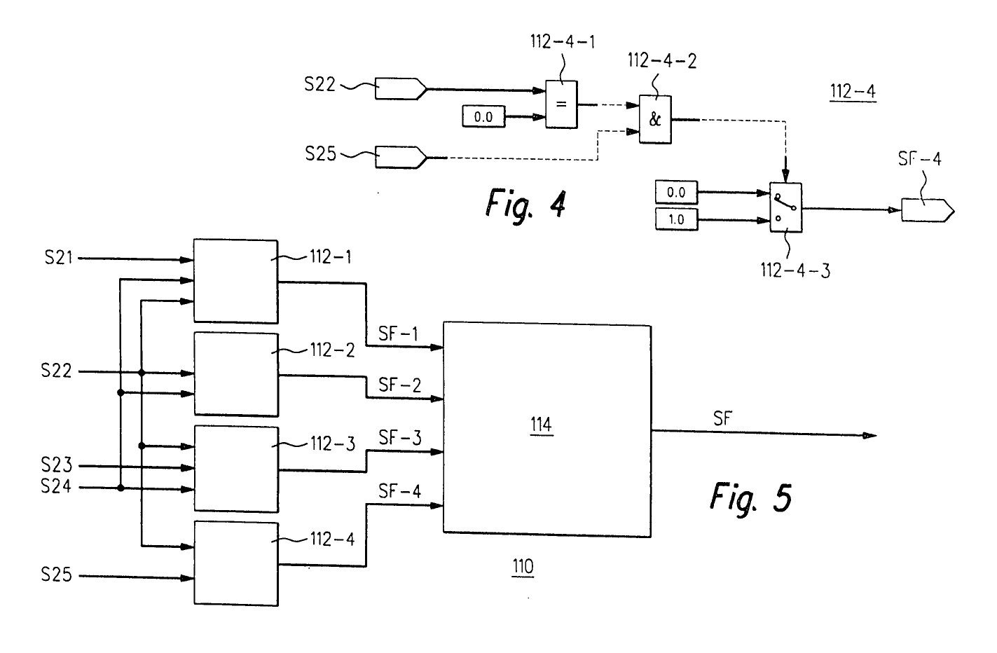

Finally, a fourth exemplary embodiment of detection device 112-4 according to the present invention is shown in FIG. 4. It includes a binary comparator unit 112-4-1 to analyze accelerator signal S22 and to output a binary signal in the form of a logical one if a non-activation of the accelerator pedal is determined, and to output a logical zero if an activation of the accelerator by the driver of the motor vehicle is determined instead. This binary output signal of comparator unit 112-4-1, in conjunction with a binary status signal S25 representing the status of a driving speed controller of a motor vehicle, is transmitted to the inputs of a logical AND-gate 112-4-2. This AND-gate generates a logical one at its output if the status signal indicates an activity of the driving speed controller and a simultaneous non-activation of the accelerator. In all other cases the AND-gate generates a logical zero at its output. The binary output signal of AND-gate 112-4-2 is used as control signal for a switching device 112-4-3. In the event that a logical zero is output at the output of logical AND-gate 112-4-2, switching device 112-4-3 is switched in such a way that it outputs a decimal zero at its output, in the form of a fourth individual driver input signal SF-4. In the other case, i.e., when a logical one is present at the output of AND-gate 112-4-2, switching device 112-4-3 outputs a decimal one at its output. In this context, the numerical values of zero or one, which are output by switching device 112-4-3, represent the driver wish for generation of the lowest possible or the highest possible overall thrust torque.

The four different exemplary embodiments of the detection device according to the present invention which have so far been described with reference to FIGS. 1 through 4, may be considered to be separate from one another, i.e., each on its own as a separate detection device in the sense of the present invention.

In contrast, however, the four exemplary embodiments 112-1- . . . -4 may also be operated in parallel, in any combination with one another, each possible combination then in turn representing a another exemplary embodiment of the detection device by itself.

FIG. 5 illustrates such a further exemplary embodiment. As shown in FIG. 5, all four afore-described exemplary embodiments of detection device 112-1 . . . -4 are combined with each other. The individual driver input signals SF-1 . . . -4, which are generated by these four exemplary embodiments in each case, are supplied to an evaluation device 114, which is configured to analyze these individual driver input signals SF-1 . . . -4 so as to generate a common driver input signal SF therefrom. This evaluation within evaluation device 114 may basically be performed in a variety of ways. One possibility is to arithmetically average the numerical values represented by the individual driver input signals SF-1 . . . -4 und to output the arithmetical average value calculated in this manner in the form of common driver input signal SF. The amount of this output numerical value then represents the magnitude of the overall thrust torque of the motor vehicle desired by the driver during the current overrun operation. An alternative possibility for analyzing individual driver input signals SF-1 . . . -4 is a maximum or minimum selection. The generated common driver input signal then represents the maximum or minimum overall thrust torque instantaneously desired by the driver.

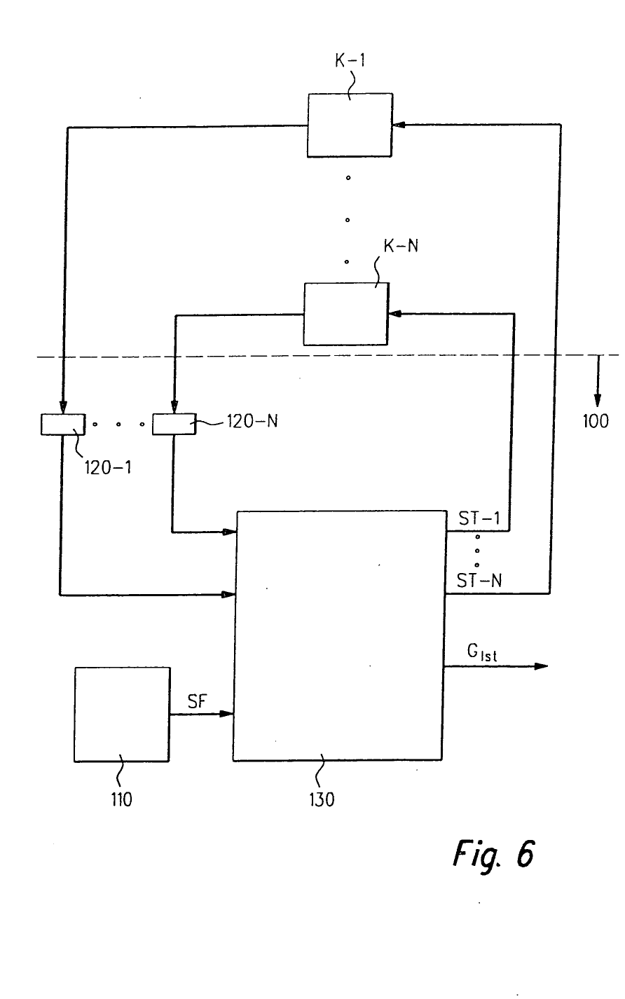

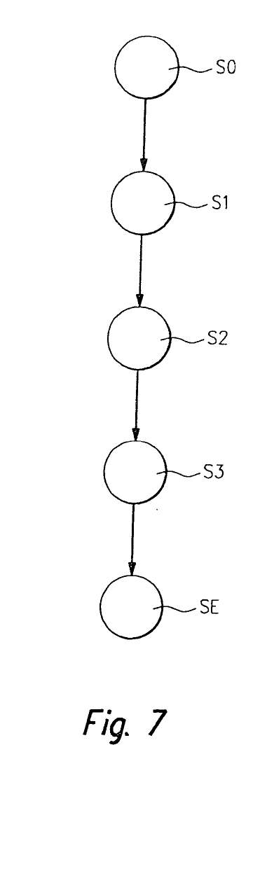

FIG. 6 shows a device 100 for coordinating the thrust torque of an internal combustion engine, in particular a diesel gasoline engine, in a motor vehicle. In other words, device 100 is used to adjust the driver-desired overall thrust torque, which was detected by detection device 110 according to the present invention. The configuration of this device 100 and its functioning method are described in greater detail in the following with reference to FIGS. 6 and 7.

To adjust the driver-desired overall thrust torque, a control unit 130 of device 100 is given information about the driver-desired overall thrust torque. In those cases where detection device 110 has only one of the four illustrated exemplary embodiments 112-1 . . . -4, this notification is implemented in the form of a direct output of the individual driver input signals SF-1 . . . -4, which are then generated by detection device 110, directly to control device 130. In contrast, control unit 130 receives the driver-desired overall thrust torque in the form of common driver input signal SF if detection device 110 encompasses a combination of said exemplary embodiments 112-1 . . . -4 and evaluation device 114.

In addition to the driver-desired setpoint overall thrust torque, control unit 130 also receives the current instantaneous overall thrust torque of the vehicle in the form of a multitude of individual instantaneous thrust torques of individual components K-1 . . . -N of the vehicle. The individual instantaneous thrust torques are recorded and provided by measuring devices 120-1 . . . -N assigned to components K-1 . . . -N. Apart from the internal combustion engine of the motor vehicle, ancillary components are also among components K-1 . . . -4. This supply of both instantaneous thrust torques and of the desired overall thrust torque is symbolized in FIG. 7 in method step S1, which follows a starting step S0. Also still in method step S1, control unit 130 adds up all instantaneous thrust torques it received individually, to form a current instantaneous overall thrust torque.

In a following method step S2, control unit 130 then implements a comparison between the driver-desired setpoint overall thrust torque and the instantaneous overall thrust torque it has ascertained. In the event that control unit 130 detects a deviation of the setpoint variable from the instantaneous variable during this comparison, it is configured to output suitable control signals C-1 . . . -N to the particular individual components K-1 . . . -N according to method step S3. With the aid of these control signals, control unit 130 then controls individual components K-1 . . . -N in such a way that the driver-desired overall setpoint thrust torque comes about in the motor vehicle. The control of the components takes the thrust torques each is currently providing into account and the maximum thrust torque that each is able to provide. For instance, the control may consist in individual components K-1 . . . -N being turned on or off or in an individual adjustment of the individual components. In addition to control signals C-1 . . . -N, control unit 130 may also output, as separate variable, the instantaneous overall thrust torque that it calculated in order to implement the comparison. Method step SE denotes the conclusion of the method.

The method is advantageously realized in the form of a computer program for device 100 for coordination of the thrust torque.

1. A detection device for detecting a wish of a driver of a motor vehicle for a specific overall thrust torque to be supplied by the motor vehicle during an instantaneous overrun operation, the device comprising:
an analyzing arrangement to analyze at least two of the following signals:
a brake signal representing a driver-initiated activation of the brake pedal,
an accelerator signal representing the instantaneous position of the accelerator,
a speed signal representing the actual speed of the vehicle,
a power-transmission signal representing a power transmission in the power train of the motor vehicle, and
a status signal representing a status of a driving speed controller of the motor vehicle; and
an output arrangement to output a driver input signal representing the desired overall thrust torque.

2. The detection device of claim 1, wherein the detection device is configured to determine, by analyzing the brake signal, the accelerator signal and the power-transmission signal that the driver desires the setting of a specific overall thrust torque that is greater in its amount than a minimally possible overall thrust torque if a power transmission exists in the power train of the motor vehicle and an accelerator is not activated at the same time, and if also configured to estimate a magnitude of the desired overall thrust torque according to a duration during which a brake pedal was depressed.

3. The detection device of claim 2, further comprising:
a binary comparator unit to determine whether the accelerator is activated by analyzing the accelerator signal;
a logical AND-gate to generate a logical one if the power transmission signal indicates a power transmission in the power train and if the accelerator signal indicates at the same time that the accelerator is not being activated, and to generate a logical zero if at least one of these conditions is not satisfied;
a binary switching device tor provide a binary switching signal in the form of a logical zero if the brake signal does not signal an activation of the brake, and in the form of a logical one in the opposite case;
a digital integrator to generate a decimal numerical value representing a duration during which the brake of the motor vehicle has been depressed;
a limiting device to limit the numerical value, output by the integrator, to values between zero and one, a zero value representing the minimally possible overall thrust torque and a value of one representing the maximally possible overall thrust torque of the motor vehicle;
a state change detector to provide a logical one if the binary output of the AND-gate changes from zero to one, and to provide a logical zero in all other possible cases;
a decision stage to initiate a reset of the integrator if the state change detector has output a logical one; and
a switching device to output a numerical value of zero, which represents the driver wish for the minimally possible overall thrust torque to be set, if a zero is output at the output of the logical AND-gate, or for outputting the restricted numerical value at the output of the limiting device if a one is output at the output of the logical AND-gate, a magnitude of the output numerical value representing a magnitude of a currently driver-desired specific overall thrust torque which is no greater than the maximally possible overall thrust torque.

4. The detection device of claim 1, wherein the detection device is configured to estimate the magnitude of the overall thrust torque desired by the driver in the following overrun operation, by at least one of analyzing a rate of change at which the accelerator position changes when overrun operation is initiated and by analyzing an original position of the accelerator when initiating the overrun operation.

5. The detection device of claim 4, further comprising:
a binary comparator unit to determine whether the accelerator is being activated by analyzing the accelerator signal;
a logical AND-gate to generate a logical one if the power transmission signal indicates a power transmission in the power train and if the accelerator signal indicates at the same time that the accelerator is not being activated, and to generate a logical zero if at least one of these conditions is not satisfied;
a delay element to delay the accelerator signal at an output of the delay element;
a memory device to store a value of the delayed accelerator signal in response to an enable signal, the stored value representing a measure for the dynamics in the change in the accelerator position;
a characteristics curve evaluation device to provide a numerical value, representing the current driver-desired overall thrust torque, in response to a value stored in the memory device and output thereby;
a state change detector to provide a logical one if the binary output of the AND-gate has changed from zero to one, and to provide a logical zero in all other possible cases;
a decision stage to generate an enable signal for the memory device when the state change detector has output a logical one; and
a switching device to output a numerical value of zero, which represents the driver wish for the minimally possible overall thrust torque to be set, if a zero is output at the output of the logical AND-gate, or to output the numerical value output by the characteristic curve evaluation device if a one is output at the output of the logical AND-gate, a magnitude of the output numerical value representing a magnitude of the current specific overall thrust torque desired by the driver, which is no greater than the maximally possible overall thrust torque.

6. The detection device of claim 1, wherein the detection device is configured to ascertain, by analyzing the accelerator signal, the speed signal and the power transmission signal, that the driver desires an increase in the overall thrust torque beyond a minimally possible overall thrust torque, as long as the motor vehicle is still accelerating, although a power transmission is given in the power train of the vehicle and the accelerator is not activated.

7. The detection device of claim 6, further comprising:
a binary comparator unit to determine whether the accelerator is activated by analyzing the accelerator signal;
a logical AND-gate to generate a logical one if the power transmission signal indicates a power transmission in the power train and if the accelerator signal indicates at the same time that the accelerator is not being activated, and to generate a logical zero if at least one of these conditions is not satisfied;
a second comparator unit to generate a binary control signal if an acceleration signal indicates an acceleration of the motor vehicle that is greater than zero;
a binary switching device to provide a binary switching signal in the form of a logical zero if the binary control signal indicates an acceleration of zero, and in the form of a logical one in all other cases;
a digital integrator, which is activated by the logical one provided by the binary switching signal, to generate a decimal numerical value representing the duration during which the motor vehicle has accelerated although it is in overrun operation;
a limiting device to limit the numerical value output by the integrator to values between zero and one, a value of zero representing the minimally possible overall thrust torque and a value of one representing the maximally possible overall thrust torque of the motor vehicle;
a state change detector to provide a logical one if the binary output of the AND-gate has changed from zero to one, and to provide a logical zero in all other possible cases;
a decision stage to initiate a reset of the integrator if the state change detector has output a logical one; and
a switching device to output a numerical value of zero, which represents the driver wish for the minimally possible overall thrust torque to be set, if a zero is output at the output of the logical AND-gate, or to output the restricted numerical value at the output of the limiting device if a one is output at the output of the logical AND-gate; the magnitude of the output numerical value representing the magnitude of the current driver-desired specific overall thrust torque, which is less than or equal to the maximally possible overall thrust torque.

8. The detection device of claim 1, wherein the detection device is configured to ascertain, by analyzing the accelerator signal and the status signal, the wish of the driver of the motor vehicle for setting the maximally possible overall thrust torque if the accelerator is not activated, but the vehicle speed controller is active at the same time.

9. The detection device of claim 8, further comprising:
a binary comparator unit to determine whether the accelerator is activated by analyzing the accelerator signal;
a logical AND-gate to generate a logical one if the status signal indicates an activity of the vehicle speed controller and if the accelerator signal indicates at the same time that the accelerator is not activated, and to generate a logical zero if at least one of these conditions is not satisfied; and
a switching device to output a numerical value of zero if a zero is output at the output of the logical AND-gate, or to output a numerical value of one if a one is output at the output of the logical AND-gate, a value of zero representing the minimally possible and a value of one representing the maximally possible overall thrust torque of the motor vehicle.

10. The detection device of claim 3, wherein individual driver input signals are provided, further comprising:
an evaluation device configured to analyze the individual driver input signals to derive therefrom a common driver input signal.

11. The detection device of claim 10, wherein the evaluation device is configured to average, which may be arithmetically, individual expressions of the driver wish for the overall thrust torque to be provided by the motor vehicle, represented by individual driver input signals, and to configure a common driver input signal so that it represents the averaged overall thrust torque desired by the driver, which results therefrom.

12. The detection device of claim 10, wherein the evaluation device is configured to select a minimum expression or a maximum expression from individual expressions of the driver wish, represented by the individual driver input signals, for an overall thrust torque to be provided by the motor vehicle and to configure the common driver input signal so that it represents a resultant minimally or maximally desired overall thrust torque.

13. A device for coordinating a thrust torque of an internal combustion engine in a motor vehicle, comprising:
at least one measuring device for recording actual instantaneous thrust torques currently provided as contributions to an instantaneous overall thrust torque of the motor vehicle by at least one of the internal combustion engine and other individual components of the motor vehicle;
a detection device for detecting a wish of a driver of a motor vehicle for a specific overall thrust torque to be supplied by the motor vehicle during an instantaneous overrun operation, the device including:
an analyzing arrangement to analyze at least two of the following signals: a brake signal representing a driver-initiated activation of the brake pedal; an accelerator signal representing the instantaneous position of the accelerator; a speed signal representing the actual speed of the vehicle; a power-transmission signal representing a power transmission in the power train of the motor vehicle; and a status signal representing a status of a driving speed controller of the motor vehicle; and
an output arrangement to output a driver input signal representing the desired overall thrust torque; and
a control device for triggering at least individual components of the motor vehicle, which contribute to the instantaneous overall thrust torque, in response to the detected instantaneous thrust torques and the driver input signal so that the desired overall thrust torque represented by the driver input signal comes about in the motor vehicle.

14. The device of claim 13, wherein the control device is configured to add up individual detected instantaneous thrust torques and to output an instantaneous overall thrust torque resulting from this addition.

15. A method for detecting the wish of a driver of a motor vehicle for a specific overall thrust torque to be supplied by the motor vehicle during an instantaneous overrun operation, the method comprising:
analyzing at least two of the following signals:
a brake signal representing a driver-initiated activation of the brake pedal,
an accelerator signal representing the instantaneous position of the accelerator,
a speed signal representing the actual speed of the vehicle,
a power transmission signal representing a power transmission in a power train of the motor vehicle, and
a status signal representing a status of a driving-speed controller of the motor vehicle; and
outputting a driver input signal representing the desired overall thrust torque.

16. The method of claim 15, wherein the determining of the overall thrust torque desired by the driver includes:
analyzing the accelerator signal to ascertain whether the accelerator is activated;
analyzing the power transmission signal to ascertain whether a power transmission exists in the power train of the motor vehicle;
ascertaining that the driver desires an overall thrust torque to be set that is greater in its amount than a minimally possible overall thrust torque when a power transmission exists in the power train of the motor vehicle and the accelerator is not activated at the same time;
analyzing the brake signal to ascertain the duration of how long the brake pedal was depressed; and
estimating a magnitude of the overall thrust torque desired by the driver according to an ascertained duration.

17. The method of claim 15, wherein the determining of the overall thrust torque desired by the driver includes:
at least one of analyzing a rate of change at which the accelerator position changes when overrun operation is initiated, and analyzing an original position of the accelerator when the overrun operation is first initiated; and
estimating a magnitude of the overall thrust torque desired by the driver in the following overrun operation according to at least one of an ascertained rate of change in the accelerator position and an ascertained original position of the accelerator when initiating the overrun operation.

18. The method of claim 15, wherein the determining of the overall thrust torque desired by the driver includes:
analyzing the accelerator signal to ascertain whether the accelerator is activated;
analyzing the power transmission signal to ascertain whether a power transmission exists in the power train of the motor vehicle;
analyzing the speed signal to ascertain an acceleration of the motor vehicle, if applicable;
ascertaining that the driver desires an increase in the overall thrust torque, such increase going beyond a minimally possible overall thrust torque, as long as the motor vehicle is still accelerating, although a power transmission in the power train of the vehicle is present and the accelerator is not activated.

19. The method of claim 15, wherein the determining of the overall thrust torque desired by the driver includes:
analyzing the accelerator signal to ascertain whether the accelerator is being activated;
evaluating the status signal to determine whether the vehicle speed controller is active; and
ascertaining that the driver desires a maximally possible overall thrust torque to be set if the accelerator is not activated but the vehicle speed controller is active at the same time.

20. A method for coordinating the thrust torque of an internal combustion engine in a motor vehicle, the method comprising:
detecting actual instantaneous thrust torques currently provided by at least one of the internal combustion engine and other individual components of the motor vehicle, as contributions to a current instantaneous overall thrust torque of the motor vehicle;
detecting a wish of the driver of the motor vehicle for a particular overall thrust torque to be provided by the motor vehicle during an instantaneous overrun operation; and
triggering at least the individual components of the motor vehicle, which contribute to the overall thrust torque, taking into account their individual contributions to the overall thrust torque in the form of their instantaneous thrust torques, so that a driver-desired overall thrust torque is set in the motor vehicle.

21. A computer program having a program code arrangement, which is executable on a processor arrangement, wherein the program code is configured to perform a process for detecting the wish of a driver of a motor vehicle for a specific overall thrust torque to be supplied by the motor vehicle during an instantaneous overrun operation, by performing the following:
analyzing at least two of the following signals:
a brake signal representing a driver-initiated activation of the brake pedal,
an accelerator signal representing the instantaneous position of the accelerator,
a speed signal representing the actual speed of the vehicle,
a power transmission signal representing a power transmission in a power train of the motor vehicle, and
a status signal representing a status of a driving-speed controller of the motor vehicle; and
outputting a driver input signal representing the desired overall thrust torque.

22. The detection device of claim 1, wherein the internal combustion engine is a diesel engine.
